(19) United States
(12) Patent Application Publication
(10) Pub. No.: US 2014/0161534 A1
(43) Pub. Date: Jun. 12, 2014

(54) FIBER-REINFORCED CONCRETE AND COMPOSITIONS FOR FORMING CONCRETE

(71) Applicants: Seyed-Ali Abolmaali, Arlington, TX (US); Joe Travis Lundy, Arlington, TX (US)

(72) Inventors: Seyed-Ali Abolmaali, Arlington, TX (US); Joe Travis Lundy, Arlington, TX (US)

(73) Assignee: Hanson Pipe & Precast LLC, Irving, TX (US)

(21) Appl. No.: 14/063,345

(22) Filed: Oct. 25, 2013

Related U.S. Application Data
(60) Provisional application No. 61/718,341, filed on Oct. 25, 2012.

(51) Int. Cl. C04B 16/06; C04B 16/04; E01F 5/00; C04B 14/48

(52) U.S. Cl. CPC C04B 16/0691; C04B 14/48; C04B 16/0633; C04B 16/04; E01F 5/005
USPC 405/124; 106/644; 524/5; 524/8

(57) ABSTRACT

Fiber-reinforced compositions for forming concrete are disclosed. A fiber-reinforced dry-cast cementitious composition includes a cementitious component, aggregate, and at least one reinforcing component selected from the group consisting of metal fibers, synthetic fibers, and rubber pieces. A fiber-reinforced non-cementitious composition includes a pozzolanic component, aggregate, and at least one reinforcing component selected from the group consisting of metal fibers, synthetic fibers, and rubber pieces. The composition excludes any cementitious component. Fiber-reinforced concrete structures obtained by hardening the above-described compositions are also disclosed.

### BACKGROUND OF THE INVENTION

The present invention relates generally to compositions for forming concrete, and more particularly, to compositions including multiple different types of reinforcing materials.

### BACKGROUND OF THE INVENTION

Concrete is one of the most widely used construction materials in the world. However, concrete typically suffers from relatively poor tensile strength and/or ductility, which may limit its suitable applications or shorten the lifetime of concrete structures. Accordingly, concrete structures conventionally include reinforcement elements (e.g., steel reinforcing bars) that help to improve the tensile strength and/or ductility of the structure.

Nonetheless, concrete structures break down at undesirable rates even with these known reinforcement elements. Thus, there is a well-recognized need in the art for cost-effective compositions for forming concrete structures that demonstrate improved performance (e.g., higher tensile strength, higher ductility, longer lifetime) than existing concrete.

### SUMMARY OF THE INVENTION

Aspects of the present invention are directed to fiber-reinforced compositions for forming concrete.

In accordance with one aspect of the present invention, a fiber-reinforced dry-cast cementitious composition is disclosed. The composition comprises a cementitious component, aggregate, and at least one reinforcing component selected from the group consisting of metal fibers, synthetic fibers, and rubber pieces.

In accordance with another aspect of the present invention, a fiber-reinforced non-cementitious composition is disclosed. The composition comprises a pozzolanic component, aggregate, and at least one reinforcing component selected from the group consisting of metal fibers, synthetic fibers, and rubber pieces. The composition excludes any cementitious component.

In accordance with yet another aspect of the present invention, fiber-reinforced concrete structures are disclosed. The fiber-reinforced concrete structures are obtained by hardening the above-described compositions.

### DETAILED DESCRIPTION OF THE INVENTION

The exemplary embodiments of the invention described herein relate to the use of reinforcement components in compositions for forming concrete.

The compositions described herein may be “cementitious compositions” or may be “non-cementitious compositions.” As used herein, the term “cementitious compositions” refers to compositions containing a “cementitious component”. A “cementitious component” is a substance that sets or hardens by reacting with water, e.g., in order to bind aggregate and form concrete. Cementitious components include, for example, Portland cement, and may include optional components, such as conventional cement additives. As used herein, the term “non-cementitious composition” refers to compositions containing only a pozzolanic component (and not any cementitious component). A “pozzolanic component” is a substance that sets or hardens via a pozzolanic reaction, e.g., by reacting with a hydroxide element.

The cementitious compositions described herein may further be described as “dry-cast” or “wet-cast” compositions. The difference between dry-cast and wet-cast compositions relates to the amount of water content used for hardening the composition, and the respective requirements of each composition will be understood by one of ordinary skill in the art. As an example, wet-cast compositions may have a water-to-cement ratio of approximately 0.40 or higher; dry-cast compositions may have a water-to-cement ratio of approximately 0.35 or less. However, it will be understood by one of ordinary skill in the art that wet-cast or dry-cast compositions may include different ratios of water-to-cement as necessary for their respective intended uses.

The exemplary compositions disclosed herein may include a number of different reinforcement components for achieving the advantages of the present invention. Generally, the reinforcements may comprise one or more of metal fibers, synthetic fibers, and/or rubber pieces. By providing these reinforcement components in suitable sizes and concentrations, the exemplary compositions described herein may be used to form concrete having improved tensile strength, compressive strength, and ductility relative to conventional concrete.

An exemplary fiber-reinforced cementitious composition will now be described in accordance with aspects of the present invention. In an exemplary embodiment, the composition is a dry-cast cementitious composition. As a general overview, the cementitious composition includes a cementitious component, aggregate, and at least one reinforcing component. Additional details of the cementitious composition are described herein.

The cementitious component may be any suitable cementitious component known to one of ordinary skill in the art. In an exemplary embodiment, the cementitious component is Portland cement. However, the invention is not intended to be so limited. Other suitable cementitious components include, for example, limestone, gypsum, or any other hydraulic cements, or any combination of any of these materials with or without Portland cement. Still other suitable cementitious components will be known to one of ordinary skill in the art from the description herein.

Similarly, the aggregate may be any suitable construction aggregate material known to one of ordinary skill in the art. The aggregate may include coarse and/or fine aggregate, and the specific particle sizes and proportions for the aggregate may be selected based on the intended use of the cementitious composition, as would be known to one of ordinary skill in the art. Suitable aggregates for use with the present invention are described in the American Society for Testing and Materials (ASTM) Specification C33/C33M-11a, entitled “Standard Specification for Concrete Aggregates”. Other suitable aggregates will be known to one of ordinary skill in the art from the description herein.

The reinforcing component is mixed with the cementitious component and the aggregate to provide increased strength, ductility, and durability to the resulting concrete. A number of categories of reinforcing components are envisioned for the cementitious composition in accordance with aspects of the present invention. These categories include metal fibers, synthetic fibers, and rubber pieces, each of which are discussed separately below. It will be understood by one of ordinary skill in the art that while these reinforcing components are discussed separately the cementitious composition may desirably include any combination of the described reinforcing components, e.g., in order to take advantage of desirable properties associated with each component.

In one exemplary embodiment, the reinforcing component comprises metal fibers. The metal fibers may be, for example, steel fibers. The length and volume of the metal fibers used may be important for the effect of the fibers on the tensile strength of the resulting concrete. Preferably, the metal fibers have a length of at least 25 mm, and more preferably, have a length within the range of 40 mm to 60 mm. The metal fibers also preferably have a ratio of length to diameter of at least 65:1, and more preferably, a ratio of between 65:1 and 80:1. Preferably, the metal fibers are present in the cementitious composition in an amount of at least five pounds of metal fibers per cubic yard of cementitious composition. Suitable metal fibers for use with the present invention are described in the ASTM SpecificationA820/A820M-11, entitled “Standard Specification for Steel Fibers for Fiber-Reinforced Concrete”. The above sizes and quantities of metal fibers may be preferable in order to achieve an optimal tensile strength of the concrete. However, it will be understood by one of ordinary skill that the above sizes and quantities are exemplary, and are not intended to be limiting of this or any other embodiment of the invention.

In another exemplary embodiment, the reinforcing component comprises synthetic fibers. The synthetic fibers may be, for example, polyolefin fibers (such as polypropylene) or may be polyamide fibers (such as nylon). The length, volume, and material of the synthetic fibers used may be important for the effect of the fibers on the tensile strength of the resulting concrete. Preferably, the synthetic fibers themselves have a tensile strength of at least 50 ksi. Preferably, the synthetic fibers have a length of at least 25 mm, and more preferably, have a length within the range of 25 mm to 60 mm. The synthetic fibers also preferably have a ratio of length to diameter of at least 30:1, and more preferably, a ratio of between 30:1 and 60:1. Preferably, the synthetic fibers are present in the cementitious composition in an amount of at least three pounds of synthetic fibers per cubic yard of cementitious composition. Suitable synthetic fibers for use with the present invention are described in Section 4.1.3 of the ASTM Specification C1116/C1116M-10a, entitled “Standard Specification for Fiber-Reinforced Concrete”. The above sizes, quantities, and materials of synthetic fibers may be preferable in order to achieve an optimal tensile strength and ductility of the concrete. However, it will be understood by one of ordinary skill that the above sizes and quantities are exemplary, and are not intended to be limiting of this or any other embodiment of the invention.

In yet another exemplary embodiment, the reinforcing component comprises rubber pieces. The rubber pieces may be, for example, shredded pieces of scrap rubber tires, or may be crumb rubber pieces. In one particular embodiment, crumb rubber is utilized as a partial replacement for fine and/or coarse aggregates. It is believed that this desirably alleviates any potential crushing of aggregates internally, thereby changing the behavioral of the composite concrete. The length and volume of the rubber pieces used may be important for the effect of the pieces on the compressive strength of the resulting concrete. Preferably, the rubber pieces have a maximum particle size of less than ¾″, and more preferably, less than ½″. Preferably, the rubber pieces are present in the cementitious composition in an amount dependent on the amount of aggregate. For example, it is preferable that the ratio of aggregate to rubber pieces be between approximately 30:1 and 35:1. The above sizes, quantities, and materials of rubber pieces may be preferable in order to achieve an optimal compressive strength of the concrete. However, it will be understood by one of ordinary skill that the above sizes and quantities are exemplary, and are not intended to be limiting of this or any other embodiment of the invention.

As set forth above, the cementitious composition may be a dry-cast cementitious composition. In such an exemplary embodiment, the cementitious composition comprises water in a ratio to the cementitious component of approximately 0.35 or less. In an exemplary embodiment in which the cementitious composition is a wet-cast cementitious composition, it will be understood that the composition may include water in a ratio to the cementitious component of approximately 0.40 or more. However, it will be understood by one of ordinary skill in the art that the above ratios of water-to-cement are exemplary, and that one of ordinary skill in the art may select different ratios of water-to-cement as necessary for their respective intended uses.

It will be understood that the cementitious composition is not limited to the above described components, but may include alternative or additional components, as would be understood by one of ordinary skill in the art. For example, the cementitious composition may include conventional additives, such as plasticizers, dispersants, retardants, accelerants, or any similar viscosity or strength modifying substances.

An exemplary fiber-reinforced non-cementitious composition will now be described in accordance with aspects of the present invention. As a general overview, the non-cementitious composition includes a pozzolanic component, aggregate, and at least one reinforcing component. Additional details of the non-cementitious composition are described herein.

The pozzolanic component may be any suitable pozzolanic component known to one of ordinary skill in the art. The pozzolanic component may be a natural or man-made component. In an exemplary embodiment, the pozzolanic component is fly ash. However, the invention is not intended to be so limited. Other suitable pozzolanic components include, for example, volcanic ash, silica fume, metakaolin, or other suitable siliceous and/or aluminous materials, or any combination thereof. Still other suitable pozzolanic components will be known to one of ordinary skill in the art from the description herein.

The aggregate may be any suitable construction aggregate material known to one of ordinary skill in the art. Suitable aggregates include those referenced above with respect to the cementitious composition. Likewise, the reinforcing component may include any of the reinforcing components referenced above, or any combination thereof. The sizes, materials, and quantities of the reinforcing components may be substantially the same as that described above with respect to the cementitious composition.

The above-described pozzolanic component serves as the primary binder component in the non-cementitious composition. Put another way, the non-cementitious composition excludes any cementitious component. As a result, the non-cementitious composition sets or hardens through a different reaction (i.e. a pozzolanic reaction) than the above-described cementitious composition. In an exemplary embodiment, the non-cementitious composition further comprises a hydroxide material (such as potassium or sodium hydroxide) in a ratio of 8 to 20 molar weight in units of water, in which water units is varied between 0.2 to 1.0.

Like the cementitious composition, it will be understood that the non-cementitious composition is not limited to the above described components, but may include alternative or additional components, as would be understood by one of ordinary skill in the art. For example, the non-cementitious composition may include conventional additives, such as plasticizers, dispersants, retardants, accelerants, or any similar viscosity or strength modifying substances.

Any of the above-described compositions may be hardened in order to form a fiber-reinforced concrete structure in accordance with aspects of the present invention. The cementitious composition may be hardened by reaction of the cementitious component with water; the non-cementitious composition may be hardened by reaction of the pozzolanic component with the hydroxide material. The concrete structure may be formed with or without conventional welded wire s reinforcing structures. The compositions described herein may be particularly suitable for forming concrete culverts.

In accordance with aspects of the present invention, concrete structures formed from the above-described compositions may exhibit superior strength, ductility, and durability when compared with conventional concrete. For one example, the concrete formed from the above-described compositions may have a tensile strength of at least 110 psi (measured by conventional means). Additionally, the concrete formed from the above-described compositions may have a compressive strength of at least 3.0 ksi (measured by conventional means). This superior strength is achieved through the use of the above-described reinforcing components in conjunction with each of the particular compositions.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A fiber-reinforced dry-cast cementitious composition comprising:
a cementitious component;
aggregate; and
at least one reinforcing component selected from the group consisting of metal fibers, synthetic fibers, and rubber pieces.

2. The cementitious composition of claim 1, wherein the reinforcing component comprises metal fibers.

3. The cementitious composition of claim 2, wherein metal fibers comprise steel fibers.

4. The cementitious composition of claim 2, wherein the metal fibers have a length of at least 25 mm.

5. The cementitious composition of claim 2, wherein the metal fibers have a ratio of length to diameter of at least 65:1.

6. The cementitious composition of claim 2, wherein the metal fibers are present in an amount of at least five pounds per cubic yard.

7. The cementitious composition of claim 1, wherein the reinforcing component comprises synthetic fibers.

8. The cementitious composition of claim 7, wherein the synthetic fibers have a tensile strength of at least 50 ksi.

9. The cementitious composition of claim 7, wherein the synthetic fibers have a length of at least 25 mm.

10. The cementitious composition of claim 7, wherein the synthetic fibers have a ratio of length to diameter of at least 45:1.

11. The cementitious composition of claim 7, wherein the synthetic fibers are present in an amount of at least three pounds per cubic yard.

12. The cementitious composition of claim 1, wherein the reinforcing component comprises rubber pieces.

13. The cementitious composition of claim 12, wherein the rubber pieces comprise shredded tires.

14. The cementitious composition of claim 12, wherein the rubber pieces have a maximum particle size of less than ¾″.

15. The cementitious composition of claim 1, further comprising water, the water provided in a ratio to the cementitious component of approximately 0.35 or less.

16. A fiber-reinforced concrete structure obtained by hardening the cementitious composition of claim 1.

17. The concrete structure of claim 16, wherein the concrete has a tensile strength of at least 110 psi.

18. The concrete structure of claim 16, wherein the concrete has a compressive strength of at least 3.0 ksi.

19. The concrete structure of claim 16, further comprising a welded wire reinforcing structure.

20. The concrete structure of claim 16, wherein the concrete structure comprises a concrete culvert.

21. A fiber-reinforced non-cementitious composition comprising:
a pozzolanic component;
aggregate; and
at least one reinforcing component selected from the group consisting of metal fibers, synthetic fibers, and rubber pieces,
wherein the composition excludes any cementitious component.

22. The composition of claim 21, wherein the reinforcing component comprises metal fibers.

23. The composition of claim 22, wherein metal fibers comprise steel fibers.

24. The composition of claim 22, wherein the metal fibers have a length of at least 35 mm.

25. The composition of claim 22, wherein the metal fibers have a ratio of length to diameter of at least 65:1.

26. The composition of claim 22, wherein the metal fibers are present in an amount of at least five pounds per cubic yard.

27. The composition of claim 21, wherein the reinforcing component comprises synthetic fibers.

28. The composition of claim 27, wherein the synthetic fibers have a tensile strength of at least 50 ksi.

29. The composition of claim 27, wherein the synthetic fibers have a length of at least 25 mm.

30. The composition of claim 27, wherein the synthetic fibers have a ratio of length to diameter of at least 45:1.

31. The composition of claim 27, wherein the synthetic fibers are present in an amount of at least three pounds per cubic yard.

32. The composition of claim 21, wherein the reinforcing component comprises rubber pieces.

33. The composition of claim 32, wherein the rubber pieces comprise shredded tires.

34. The composition of claim 32, wherein the rubber pieces have a maximum particle size of less than ¾″.

35. The composition of claim 21, further comprising a hydroxide material in a quantity of approximately 20 molar weight.

36. A fiber-reinforced concrete structure obtained by hardening the composition of claim 21.

37. The concrete structure of claim 36, wherein the concrete has a tensile strength of at least 110 psi.

38. The concrete structure of claim 36, wherein the concrete has a compressive strength of at least 3.0 ksi.

39. The concrete structure of claim 36, further comprising a welded wire reinforcing structure.

40. The concrete structure of claim 36, wherein the concrete structure comprises a concrete culvert.
